(19) United States
(12) Patent Application Publication
(10) Pub. No.: US 2015/0367148 A1
(43) Pub. Date: Dec. 24, 2015

(54) BELAYING AND RAPPEL DEVICE HAVING BLOCKING RECESS

(71) Applicant: ETABLISSEMENTS SIMOND, Les Houches (FR)

(72) Inventors: David Caude, Passy (FR); Romain Molliex, Scionzier (FR)

(21) Appl. No.: 14/328,796

(22) Filed: Jul. 11, 2014

(30) Foreign Application Priority Data
Jun. 20, 2014 (FR) 14 55696

(51) Int. Cl. A62B 1/18; A63B 29/02

(52) U.S. Cl. CPC A62B 1/18; A63B 29/02

(57) ABSTRACT

Belaying and rappel device (1) for controlling the unwinding of a rope, comprising:
a tubular rigid body (2) which extends along a longitudinal axis (A-A) between a rope introduction end (3) and a rope retention end (4), the body (2) having at least one through-tunnel (5) which has an oblong cross section which extends along an extension axis (B-B) for the passage of a half-loop of the rope between the rope introduction end (3) and the rope retention end (4), the through-tunnel (5) being limited by two opposing lateral body walls (6, 7) and by two opposing front body walls (8, 9),
a retention bow (10) which is fixedly joined to the body (2) and which extends the body (2) beyond the rope retention end (4) in order to allow the passage and the retention of a fitted carabiner-type hook which extends through said rope half-loop,
at least one of the opposing lateral body walls (6, 7) being provided with a blocking aperture (11, 12) which extends from the rope introduction end (3) and which is shaped for the lateral passage of one of the strands of the rope half-loop in order to ensure its selective blocking.

### TECHNICAL FIELD OF THE INVENTION

The present invention relates to a belaying and rappel device which is intended to be used for controlling the unwinding of a rope, for example, for the descent of a person along a rope, or for belaying a person.

Various structures of belaying and rappel devices, for example, such as that described in document FR 2 631 325 A1, are already known.

Such a known device comprises:
a tubular rigid body which extends along a longitudinal axis between a rope introduction end and a rope retention end, the body having a through-tunnel which has an oblong cross section which extends along an extension axis, the tunnel allowing the passage of a half-loop of the rope between the rope introduction end and the rope retention end, the tunnel being limited by two opposing lateral body walls at one side and the other of the extension axis and by two opposing front body walls,
a retention bow which is fixedly joined to the body and which extends the body beyond the rope retention end, and which is shaped to allow the passage and the retention of a fitted carabiner-type hook which extends through the rope half-loop.

In this known device, when the rope half-loop is engaged in the tunnel and a carabiner-type hook extends through the bow and the rope half-loop at the rope retention end, the two strands of the rope half-loop at the rope introduction end form a retention strand and a connection strand, respectively.

The connection strand is intended either to be fixedly joined to a load to be retained, such as a climber, the carabiner-type hook then being connected to a fixed location in order to belay the climber, or to be fixedly joined to a fixed location for the abseiling descent of a user who is fixedly joined to the carabiner-type hook.

In both cases, the retention strand is intended to be retained by the user in order to ensure friction-type braking of the rope loop on the inner faces of the two front walls of the through-tunnel and on the carabiner-type hook portion which extends through the half-loop. This friction-type braking considerably facilitates the retention of the connection strand by the user, the force which the user has to apply to the retention strand then being very much lower than the tension produced on the connection strand.

When the rope slides, the presence of the bow prevents the body from moving away from the carabiner-type hook which extends through the rope half-loop, but the bow is sufficiently large to allow displacement of the carabiner-type hook inside the opening defined by the bow. As soon as great tension is applied to the rope, for example, in the event of a fall of a climber, the carabiner-type hook is pressed against the rope retention end, increasing the friction of the rope against the front walls of the body.

This known device has the advantage of simplicity and low weight and allows efficient braking to be ensured on the ropes without substantially damaging the ropes by means of destranding. However, a disadvantage of this known device is that, during normal operation, the blocked retention of the rope of the secured climber requires the user to permanently apply a retention force to the rope retention strand. If no such retention force is applied to the retention strand, the device is not capable of preventing the unwinding of the rope. In the same manner, in the case of a user abseiling along a rope, the braking of the user requires that a retention force be permanently applied to the retention strand. If no such retention force is applied to the retention strand, the device is not capable of preventing the unwinding of the rope for intentional retention in a secured position along the rope. In order to retain a secured climber in position, or in order to retain the abseiling user in position, it is again necessary to permanently apply such a retention force to the retention strand. Such a permanent force may be found to become tiring when the rope continues to be used for a long period of time.

### SUMMARY OF THE INVENTION

The present invention is intended to prevent the disadvantages of this type of known belaying and rappel device by allowing the two functions of descending and belaying to be carried out without any change, but also by allowing the user to selectively retain the rope in a blocked state without having to permanently apply a significant retention force to the rope retention strand. In this manner, during the sequences for intentional blocking retention of the rope, the user no longer has to apply a significant retention force to the retention strand, and his muscular fatigue is thus considerably reduced.

In order to achieve these objectives and others, the invention proposes a belaying and rappel device for controlling the unwinding of a rope, comprising:

a tubular rigid body which extends along a longitudinal axis between a rope introduction end and a rope retention end, the body having at least one through-tunnel which has an oblong cross section which extends along an extension axis, the through-tunnel being shaped to allow the passage of a half-loop of the rope between the rope introduction end and the rope retention end, the through-tunnel being limited by two opposing lateral body walls at one side and the other of the extension axis and by two opposing front body walls,

a retention bow which is fixedly joined to the body and which extends the body beyond the rope retention end and which is shaped to allow the passage and the retention of a fitted carabiner-type hook which extends through the rope half-loop,

wherein:

at least one of the opposing lateral body walls is provided with a blocking aperture which extends from the rope introduction end and which is shaped for the lateral passage of one of the strands of the rope half-loop in order to ensure its selective blocking.

In order to ensure intentional blocking of the rope, the user may engage the retention strand transversely in the blocking aperture, thereby considerably increasing the friction of the rope on the body of the device. It is thus no longer necessary to apply a significant retention force to the retention strand.

Preferably, the blocking aperture extends from the rope introduction end in a generally oblique direction relative to the longitudinal axis of the through-tunnel. In this manner, the tension of the rope maintains the orientation of the body of the device so as to maintain efficient friction during the blocking action.

According to a preferred embodiment, the blocking aperture comprises an introduction opening which is located in a central position of an introduction end edge of the corresponding lateral body wall. This arrangement also contributes to the maintenance of good orientation of the body under rope tension in order to ensure efficient braking during the blocking action.

The blocking aperture may advantageously have a bent profile, with a first portion which is generally parallel with the longitudinal axis and which extends from the rope introduction end, and with a second generally transverse portion which extends the first portion as far as a base of the blocking aperture. This arrangement promotes the engagement and the retention of the rope retention strand in the aperture, preventing inadvertent release of the retention strand. The user can then relax his effort after ensuring that the retention strand is correctly engaged in the aperture.

According to a first embodiment of the belaying and rappel device, the rigid body comprises a single through-tunnel which is shaped for the passage of a single half-loop of the rope, and the two opposing lateral walls of the through-tunnel each comprise a blocking aperture, thereby allowing the passage of one of the strands of the rope half-loop in one or other of the blocking apertures. Such a device which is suitable for braking a single rope is thus produced.

According to a second embodiment of the belaying and rappel device, the rigid body comprises two through-tunnels having oblong cross sections, the through-tunnels being parallel and arranged side by side and separated from each other by an intermediate wall, each of the through-tunnels being shaped for the passage of a respective rope half-loop and being provided with a blocking aperture which is provided in the external lateral wall thereof and which extends from the rope introduction end, the blocking apertures being parallel with each other and each being shaped for the transverse passage of one of the strands of the respective rope half-loop in order to ensure its selective blocking. Such a device which is suitable for braking a double rope is thus produced.

### BRIEF DESCRIPTION OF THE DRAWINGS

Other objectives, features and advantages of the present invention will be appreciated from the following description of specific embodiments, given with reference to the appended figures, in which:

FIG. 1 is a perspective view of a belaying and rappel device according to a first embodiment of the present invention, which device comprises a single through-tunnel and two blocking apertures and which is suitable for braking on a single rope, with a centered retention bow, viewed from the side of the end of the retention rope;

FIG. 2 is a perspective view of a belaying and rappel device according to a second embodiment of the present invention, which device comprises a single through-tunnel and two blocking apertures and which is suitable for braking on a single rope, with an off-centre retention bow, viewed from the side of the end of the retention rope;

FIG. 3 is a perspective view of the belaying and rappel device according to the embodiment of FIG. 1, viewed from the side of the rope introduction end;

FIG. 4 is a perspective view of a belaying and rappel device according to a third embodiment of the present invention, which device comprises a single through-tunnel and a single blocking aperture and which is suitable for braking on a single rope, with an off-center retention bow, viewed from the side of the rope introduction end;

FIG. 5 is a perspective view of a belaying and rappel device according to a fourth embodiment of the present invention, which device comprises two parallel through-tunnels and two blocking apertures and which is suitable for braking on a double rope, with a centered retention bow, viewed from the side of the rope introduction end;

FIG. 6 is a perspective view of a belaying and rappel device according to a fifth embodiment of the present invention, which device comprises two parallel through-tunnels and two blocking apertures and which is suitable for braking on a double rope, with a centered retention bow, viewed from the side of the rope introduction end, with a protuberance having a through-passage;

FIG. 7 is a perspective view of the belaying and rappel device of FIG. 1, in a position for use on a rope during normal unwinding; and

FIG. 8 is a perspective view of the belaying and rappel device of FIG. 1, in a position for blocking use on a rope.

### DESCRIPTION OF THE PREFERRED EMBODIMENTS

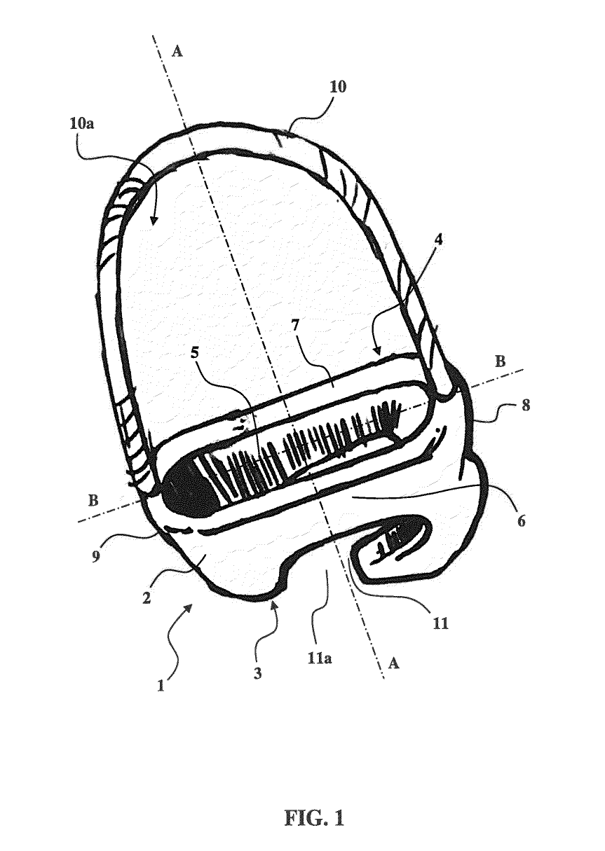

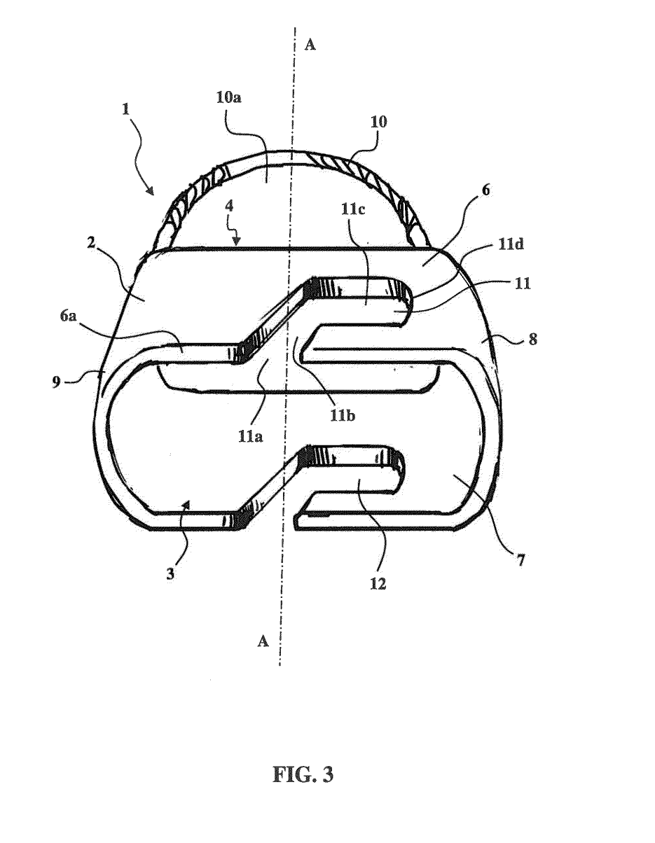

The first embodiment illustrated in FIGS. 1 and 3 will be considered first.

In this embodiment, the belaying and rappel device 1 comprises a tubular rigid body 2 which extends along a longitudinal axis A-A between a rope introduction end 3 and a rope retention end 4. The body 2 comprises a single through-tunnel 5 having an oblong cross section which extends along an extension axis B-B. The through-tunnel 5 is shaped to allow the passage and the guiding of a rope loop between the rope introduction end 3 and the rope retention end 4. The through-tunnel 5 is limited by two opposing lateral body walls 6 and 7 at one side and the other of the extension axis B-B, and by two opposing front body walls 8 and 9 which join the ends of the two lateral walls 6 and 7. The distance which separates the two lateral walls 6 and 7 is selected to be slightly greater than the maximum diameter of the ropes with which the belaying and rappel device 1 is intended to be used. In practice, this distance may be approximately 12 mm. In contrast, the distance which separates the two front walls 8 and 9 is greater in order to allow the engagement of the rope half-loop. In practice, this distance may be approximately 30 mm. In this manner, good guiding of the rope half-loop is ensured.

According to an advantageous variant, the opposing front walls 8 and 9 of the body may generally be convergent in the direction of the rope introduction end 3. The sliding action of the rope is thus promoted, but without disrupting the braking action.

A retention element 10, for instance in shape of a bow, which is fixedly joined to the body 2, extends the body 2 beyond the rope retention end 4.

In the embodiment illustrated in the figures, the retention bow 10 is a metal cable which forms a half-loop whose ends are fixed to one and the other of the front walls 8 and 9 of the body 2, respectively. The loop 10a formed by the retention bow 10 and by the rope retention end 4 of the body 2 has a dimension which is suitable for allowing the passage and the retention of a carabiner-type hook which is fitted, as will be described below. In a form produced by a metal cable, the retention bow 10 is resiliently flexible.

In this embodiment, the retention bow 10 is arranged in a plane which is generally parallel with the lateral walls 6 and 7 of the body 2, and the ends thereof are connected to the front walls 8 and 9 of the body 2, substantially at the center of the walls.

In this embodiment, the two opposing lateral walls 6 and 7 of the through-tunnel 5 each comprise a blocking aperture or slit, or recess, namely a first blocking aperture 11 in the first lateral wall 6 and a second blocking aperture 12 in the second lateral wall 7, respectively.

The first blocking aperture 11 comprises an introduction opening 11a which is located in a central position of an introduction end edge 6a of the corresponding lateral body wall 6. The first blocking aperture 11 has a bent profile, having a first portion 11b which extends from the rope introduction end 3, and having a generally transverse second portion 11c which extends the first portion 11b as far as a base 11d of the first blocking aperture 11. The first portion 11b is orientated in an oblique direction relative to the longitudinal axis A-A, and the second portion 11c is generally perpendicular to the longitudinal axis A-A. The base 11d of the first aperture 11 is close to the connection zone between the first lateral wall 6 and the first front wall 8. The width of the first blocking aperture 11 is shaped to allow the passage of a rope strand, in order to ensure the selective blocking thereof.

In the embodiment illustrated, the retention end 4 of the body 2 is generally planar.

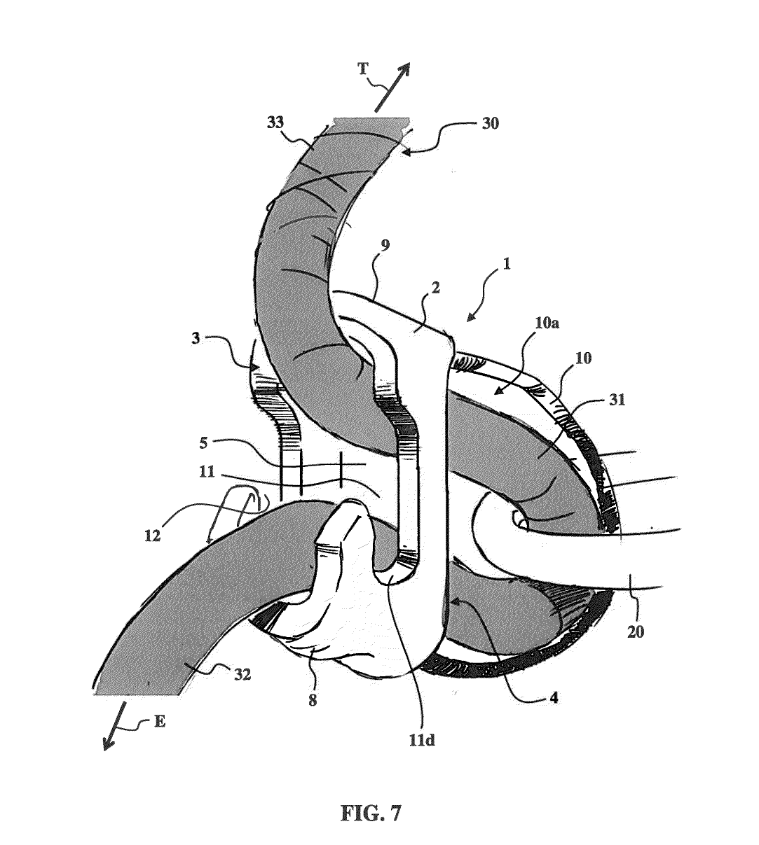

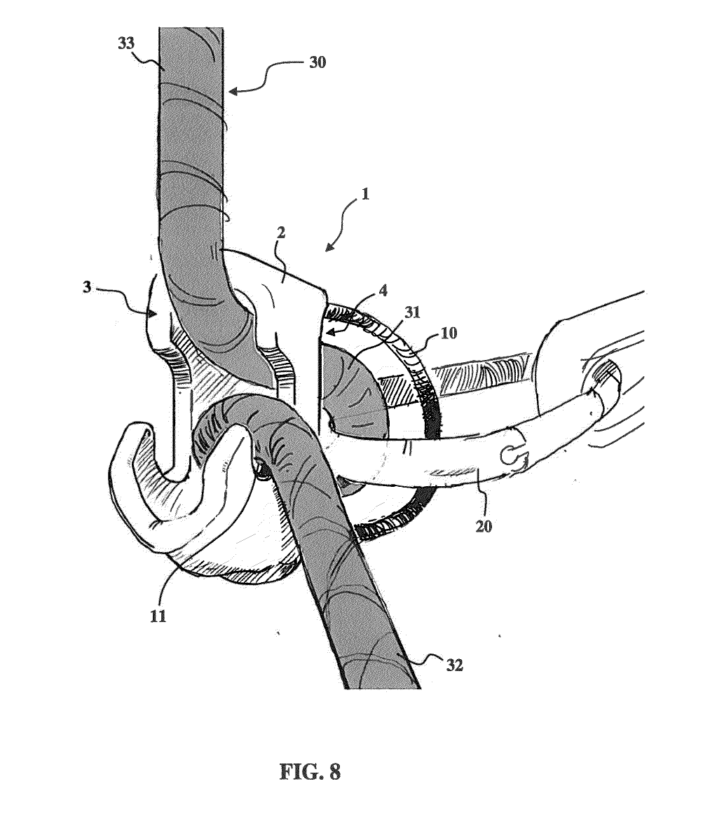

FIGS. 7 and 8, which illustrate the use of the belaying and rappel device 1 in the embodiment of FIGS. 1 and 3, will now be taken into consideration.

To this end, the belaying and rappel device 1 is associated with a carabiner-type hook 20 and a rope 30.

The carabiner-type hook 20 is of known type, having a carabiner-type hook body in the form of an open ring which is provided with a closing member, the body of the carabiner-type hook 20 extending through the loop 10a formed by the half-loop of the bow 10 and by the portion of the body 2 which constitutes the rope retention end 4.

There is produced with the rope 30 a half-loop 31 which is engaged in the through-tunnel 5 from the rope introduction end 3. The half-loop extends beyond the rope retention end 4 so that it can be passed through by the portion of the carabiner-type hook 20, which portion itself extends through the loop 10a of the bow 10. At one side and the other of the half-loop 31, the rope 30 comprises a retention strand 32 and a connection strand 33. The retention strand 32 is the rope strand which is connected to the half-loop 31 in the zone close to the first front wall 8 which itself is close to the base 11d of the blocking aperture 11. The connection strand 33 is the rope strand which is connected to the half-loop 31 in the zone close to the second front wall 9.

In the position illustrated in FIG. 7, the belaying and rappel device 1 is located in an appropriate arrangement in order to produce unwinding with weak braking of the rope 30, without substantially opposing this unwinding action. In this instance, the carabiner-type hook 20 is remote from the body 2 and the retention strand 32 leaves the through-tunnel 5 directly without being engaged in one or other of the blocking apertures 11 and 12. If the user applies a retention force E to the retention strand 32, this ensures the friction of the rope 30 against the front walls 8 and 9 of the body 2 and against the carabiner-type hook 20 which moves closer to the body 2, and this allows the user to readily support the tension T of the connection strand 33 which connects the belaying and rappel device 1 to a load (in order to belay a climber) or to a fixed location (for abseiling descent).

FIG. 8 illustrates the belaying and rappel device 1 in an arrangement which allows the blocking of the rope 30 to be readily maintained. In this case, the difference, compared with the use illustrated in FIG. 7, is that the retention strand 32 is engaged laterally in one of the blocking apertures, for example, the first blocking aperture 11. The carabiner-type hook 20 is pressed against the body 2. The user can then substantially reduce, or even cancel, the retention force which he has to apply to the retention strand 32 of the rope 30.

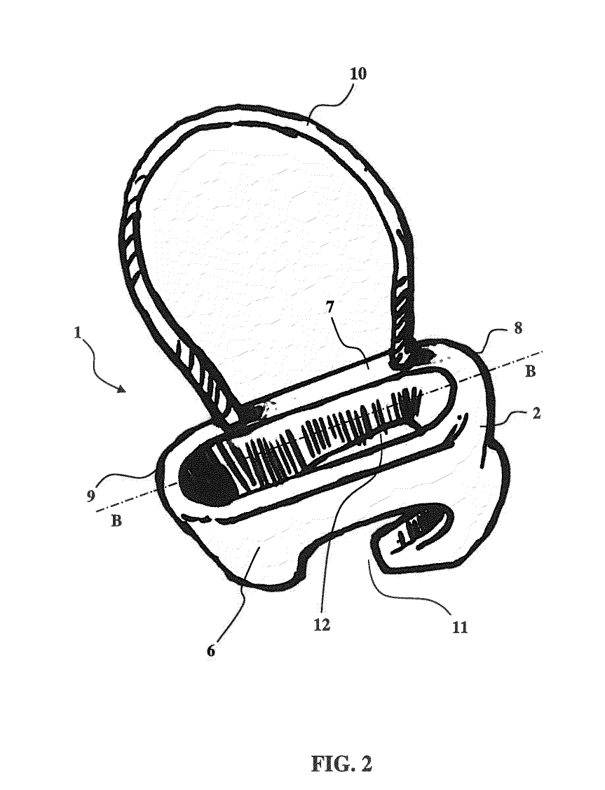

The second embodiment of the present invention, illustrated in FIG. 2, will now be considered. This second embodiment takes up the same elements as the first embodiment illustrated in FIGS. 1 and 3. The only difference is the position of the bow 10 which, in this second embodiment, is laterally eccentric relative to the extension axis B-B: the two ends of the cable which forms the bow 10 are connected to the body 2 in the connection zones between the second lateral wall 7 and the front walls 8 and 9. The use of the belaying and rappel device according to this second embodiment is identical to that illustrated in relation to the first embodiment in FIGS. 7 and 8. This second embodiment has the advantage of facilitating the release of the rope loop from the carabiner-type hook while reducing the risk of a simultaneous release of the bow 10 from the carabiner-type hook.

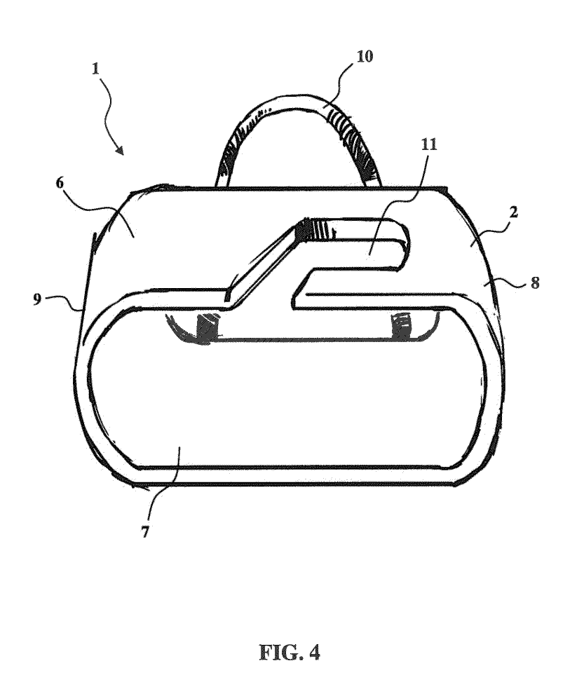

The third embodiment of the present invention illustrated in FIG. 4 will now be considered. This third embodiment takes up the same necessary elements as the second embodiment illustrated in FIG. 2. The only difference is the presence of a single blocking aperture 11, the second blocking aperture 12 having been omitted. It will be understood that the presence of a single blocking aperture 11 is sufficient to obtain the blocking of the rope 30 as illustrated in FIG. 8.

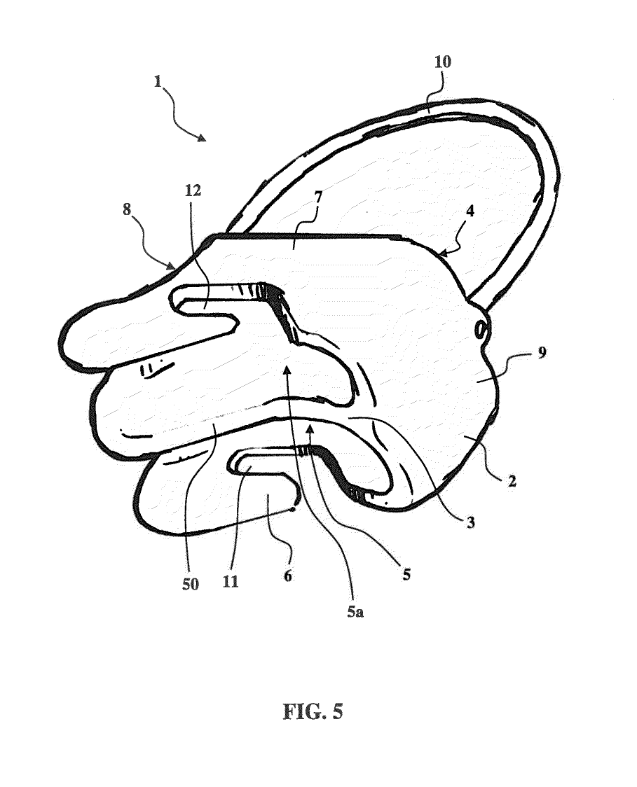

The fourth embodiment of the present invention illustrated in FIG. 5 will now be considered. In this fourth embodiment there are a rigid body 2, a bow 10, two lateral walls 6 and 7, two front walls 8 and 9, an introduction end 3 and a retention end 4. The rigid body 2 comprises two through-tunnels 5 and 5a which each have an oblong cross section, the oblong cross sections being developed along extension axes which are parallel with each other, the through-tunnels 5 and 5a being parallel and arranged side by side in a state separated from each other by an intermediate wall 50 which is itself parallel with the two lateral walls 6 and 7. Each of the through-tunnels 5 and 5a is shaped for the passage and the guiding of a respective rope loop, and the cross section thereof is to this end selected as in the embodiment of FIGS. 1 and 3. Each of the through-tunnels 5 and 5a is provided with a respective blocking aperture which is provided in the external lateral wall thereof formed by the corresponding lateral wall 6 or 7 and which extends from the rope introduction end 3. The blocking apertures 11 and 12 are parallel with each other and each shaped for the through-passage of one of the strands of the respective rope loop in order to ensure the selective blocking thereof. It should be understood that the use of the device according to this fourth embodiment is identical to the use illustrated in FIGS. 7 and 8, the difference being that this fourth embodiment allows the braking and blocking of a double rope, that is to say, a rope which comprises two connection strands.

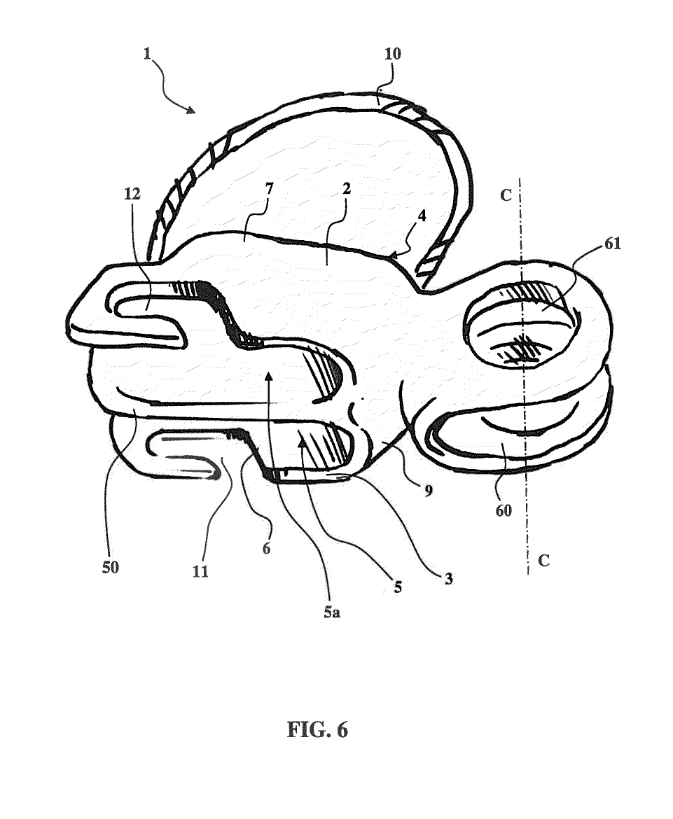

A fifth embodiment of the present invention illustrated in FIG. 6 will now be considered. This fifth embodiment takes up the elements of the fourth embodiment of FIG. 5, with the difference that the body further comprises, on the front wall 9 thereof most remote from the development direction of the blocking apertures 11 and 12, a protuberance 60 which is provided with a through-passage 61 along an axis C-C which is generally perpendicular relative to the lateral walls 6 and 7 of the body 2. The main function of the protuberance 60 is to allow the belaying device to be fixed to an anchoring location. The protuberance 60 may also act as a maneuvering lever in order to modify the inclination of the body 2 and to facilitate the unblocking of the rope, for example, after a violent braking sequence in order to stop the fall of a belayed climber.

The present invention is not limited to the embodiments which have been explicitly described, but rather it includes the different variants and generalizations thereof contained within the scope of the appended claims.

1. A belaying and rappel device (1) for controlling the unwinding of a rope (30), comprising:
a tubular rigid body (2) which extends along a longitudinal axis (A-A) between a rope introduction end (3) and a rope retention end (4), the body (2) having at least one through-tunnel (5) which has an oblong cross section which extends along an extension axis (B-B), the through-tunnel (5) being shaped to allow the passage of a half-loop (31) of the rope (30) between the rope introduction end (3) and the rope retention end (4), said through-tunnel (5) being limited by two opposing lateral body walls (6, 7) at one side and the other of the extension axis (B-B) and by two opposing front body walls (8, 9),
a retention bow (10) which is fixedly joined to the body (2) and which extends the body (2) beyond the rope retention end (4) and which is shaped to allow the passage and the retention of a fitted carabiner-type hook (20) which extends through said rope half-loop (31),
wherein:
at least one of the opposing lateral body walls (6, 7) is provided with a blocking aperture (11, 12) which extends from the rope introduction end (3) and which is shaped for the lateral passage of one of the strands (32) of the rope half-loop (31) in order to ensure its selective blocking.

2. The belaying and rappel device (1) as claimed in claim 1, wherein the blocking aperture (11, 12) extends from the rope introduction end (3) in a generally oblique direction relative to the longitudinal axis (A-A) of the through-tunnel (5).

3. The belaying and rappel device (1) as claimed in claim 1, wherein the blocking aperture (11, 12) comprises an introduction opening (11a) which is located in a central position of an introduction end edge (6a) of the corresponding lateral body wall (6).

4. The belaying and rappel device (1) as claimed in claim 1, wherein the blocking aperture (11, 12) has a bent profile, with a first portion (11b) which is generally parallel with the longitudinal axis (A-A) and which extends from the rope introduction end (3), and with a second generally transverse portion (11c) which extends the first portion as far as a base (11d) of the blocking aperture (11, 12).

5. The belaying and rappel device (1) as claimed in claim 1, wherein the rigid body (2) comprises a single through-tunnel (5) which is shaped for the passage of a single half-loop (31) of the rope (30), and wherein the two opposing lateral walls (6, 7) of the through-tunnel (5) each comprise a blocking aperture (11, 12), thereby allowing the passage of one of the strands (32) of the rope half-loop (31) in one or other of the blocking apertures (11, 12).

6. The belaying and rappel device (1) as claimed in claim 1, wherein the rigid body (2) comprises two through-tunnels (5, 5a) having oblong cross sections, the through-tunnels (5, 5a) being parallel and arranged side by side and separated from each other by an intermediate wall (50), each of the through-tunnels (5, 5a) being shaped for the passage of a respective rope half-loop and being provided with a blocking aperture (11, 12) which is provided in the external lateral wall (6, 7) thereof and which extends from the rope introduction end (3), the blocking apertures (11, 12) being parallel with each other and each being shaped for the transverse passage of one of the strands of the respective rope half-loop in order to ensure its selective blocking.

7. The belaying and rappel device (1) as claimed in claim 1, wherein the retention bow (10) is arranged in a plane which is generally parallel with the lateral walls (6, 7) of the body (2).

8. The belaying and rappel device (1) as claimed in claim 1, wherein the retention bow (10) is resiliently flexible.

9. The belaying and rappel device (1) as claimed in claim 1, wherein the opposing front walls (8, 9) of the body (2) are generally convergent in the direction of the rope introduction end (3).

10. The belaying and rappel device (1) as claimed in claim 1, wherein the body (2) further comprises, on the front wall (9) thereof most remote from the development direction of the blocking apertures (11, 12), a protuberance (60) which is provided with a through-passage (61) along an axis (C-C) which is generally perpendicular relative to the lateral walls (6, 7) of the body (2).
